(19) United States
(12) Patent Application Publication
(10) Pub. No.: US 2026/0120083 A1
(43) Pub. Date: Apr. 30, 2026

(54) SYSTEMS AND METHODS FOR USING ENCRYPTION FOR SELECTIVE OBFUSCATION OF DISTRIBUTED LEDGER TRANSACTIONS

(71) Applicant: HSBC Software Development (Guangdong) Limited, Guangdong (CN)

(72) Inventors: Peng ZHAO, Shanghai (CN); Wei Ming ZHUANG, Shanghai (CN)

(21) Appl. No.: 19/431,620

(22) Filed: Dec. 23, 2025

(30) Foreign Application Priority Data
Dec. 30, 2024 (CN) 202411978306.4

(51) Int. Cl. G06Q 20/36

(52) U.S. Cl. CPC G06Q 20/367

(57) ABSTRACT

An improved selective privacy based approach is proposed for selective obfuscation of distributed ledger transaction records of a specially configured blockchain smart contract, the approach describing a cryptographic process, along with a corresponding apparatus and computer program products using zero-knowledge proofs and a set of auditor generated public/private key pairs. The process includes establishing two new cryptographic parameters for a computational transfer function, which are used as part of a Sigma protocol for proving relationship between generated Pedersen commitment values.

### CROSS-REFERENCE TO RELATED APPLICATIONS

This application claims priority to Chinese Patent Application No. 202411978306.4 filed on Dec. 30, 2024, the entire disclosure of which is hereby incorporated by reference in its entirety.

### FIELD

The present application relates to computer architecture and inter-process encrypted data communications and more specifically, to systems and methods for using encryption for selective obfuscation of distributed ledger transactions.

### INTRODUCTION

A technical challenge with decentralized blockchain transactions is that the recordal process creates an immutable record that is traversable by third parties to identify a sender wallet address, a receiver wallet address, and a field corresponding to the amount being transferred. This privacy issue is a result of the technical characteristics and architecture of the transaction propagation and consensus mechanism of a blockchain as distributed ledgers are updated with block updates.

### SUMMARY

While it is possible to obfuscate a transaction using privacy enhanced transfer protocols, it is desirable to have selective privacy where an auditor mechanism or tool is able to securely identify the underlying parties and transaction amounts.

An improved selective privacy based approach is proposed for selective obfuscation of distributed ledger transaction records, the approach describing a cryptographic process, along with a corresponding apparatus and computer program products using zero-knowledge proofs and a set of auditor generated public/private key pairs. The process includes establishing two new cryptographic parameters for a computational transfer function, C[i], an encrypted account balance change, the two cryptographic parameters including (1) auditC[i], a result of encrypting the account balance changes using Pedersen commitment with the public key of the regulatory authority bound to the user, which are used as part of a Sigma protocol for proving relationship between generated Pedersen commitment values, and (2) auditProof[i], the proof used to demonstrate that the account balance changes encrypted in both C[i] and auditC[i] are the same.

The proposed approach involves a selectable number of additional accounts in transactions to obfuscate the identity of the sender and receiver within the additional accounts, and only a computing device with the auditor private key is able to determine the identity of the sender and receiver, as well as the amount being transferred using the approach described herein. While the additional computing process steps necessarily incur additional computational costs (and thus blockchain transaction fees), Applicants conducted testing of the new approach in a practical application integration setting and found that the increase in transaction cost was kept within a practical limit.

Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is a block schematic diagram of an example system for using encryption for selective obfuscation of distributed ledger transactions.

FIG. 2 is an example account list, according to some embodiments.

FIG. 3 is a set of method steps showing an approach for executing a transaction, according to some embodiments.

FIG. 4 is a computing method for an audit process that can automatically be conducted by an auditor node or an auditor computing process, according to some embodiments.

FIG. 5 is a transaction cost graph, according to some embodiments.

FIG. 6 is an example block schematic of a smart contract data object, according to some embodiments.

FIG. 7 shows an example set of method steps for performing a private transaction using the proposed smart contract, according to some embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

While it is possible to obfuscate a transaction using privacy enhanced transfer protocols, it is desirable to have selective privacy where an auditor mechanism or tool is able to securely identify the underlying parties and transaction amounts. A private transaction refers to a transaction where only the participants involved (i.e., the sender and receiver) are able to know the full details of the transaction, including the sender, receiver, and transaction amount.

All other third parties are unable to access this information. This technical design ensures the privacy of the transaction, preventing unauthorized parties from viewing the transaction details. Privacy concerns are becoming increasingly prominent. While the transparency characteristics of blockchains ensures data security and transaction traceability, it also raises risks of personal and business data exposure. Public transaction records can reveal user identities, asset details, and transaction behaviors, leading to privacy issues that may result in economic losses and security threats.

Consequently, privacy transactions have become a critical need in the blockchain space to protect users' sensitive information from unnecessary exposure. A level of privacy from third parties is useful for sensitive transactions as between parties. Examples of sensitive transactions can include payroll transactions, inter-family transfers (e.g., one child having an allowance greater than another child), among others. However, a regulator may desire to be able to uncloak these transactions for tax auditing purposes, among others.

In the context of Central Bank Digital Currencies (CBDCs) and stablecoins, the demand for privacy transactions is especially significant. However, fully anonymous privacy transaction schemes face major legal and regulatory challenges. To prevent money laundering, terrorism financing, and other illegal activities, regulators must be able to monitor and audit transaction activities. Fully anonymous systems, however, could render regulation ineffective, making it more difficult to control illicit activities. Therefore, the challenge in designing privacy transaction systems for CBDCs and stablecoins lies in achieving privacy protection while also meeting regulatory requirements, for example, by providing a robust but private approach for the regulator to use a tool to uncloak certain transactions.

To achieve both privacy and regulation on public blockchains, a solution is proposed that uses technical protection mechanisms and a specific approach for encryption, as well as corresponding specialized computer data structures and architecture to provide a technical mechanism that is specially configured to both (1) protect the privacy of transaction participants, while (2) allowing authorized institutions to audit the transactions. The approach is configured such that regular participants cannot access specific transaction details (such as the sender, receiver, and amount), while regulatory authorities can lawfully obtain this data and verify its consistency with the actual transaction records. Achieving this balance requires not only technological innovation but also careful consideration of legal compliance and regulatory frameworks to support the healthy development of digital currencies in the future.

An example approach for private transactions is Anonymous Zether, an EVM-based privacy payment system designed to protect the privacy of blockchain transactions. It uses encryption and zero-knowledge proof (ZKP) technology to conceal the sender, receiver, and transaction amount while maintaining the system's security and transparency. Zether employs Elliptic Curve Cryptography (ECC) to protect transaction data and uses zero-knowledge proofs to verify the validity of transactions without revealing specific information.

Building upon this foundation, Anonymous Zether further enhances its anonymity features. Anonymous Zether leverages zero-knowledge proofs, allowing transaction participants to verify the validity of a transaction without disclosing any concrete transaction details. In Anonymous Zether, ZKP is used to ensure that the transaction amount is positive, does not exceed the account balance, that the sender is indeed the owner of the account, and that the receiver's address and amount are validated while maintaining privacy. This mechanism ensures that participants can only view encrypted account balances and transaction amounts, thus preventing information leakage.

Additionally, Anonymous Zether utilizes ring signatures to ensure the anonymity of both the sender and the receiver. Ring signatures allow the transaction sender to select a group of potential signers, making it impossible for external parties to identify the specific signer, thus concealing the sender's identity in the transaction. At the same time, the receiver's identity is protected through obfuscation techniques. In a transaction, the system hides the receiver's identity within a group of possible receivers, ensuring that external parties cannot easily determine the actual recipient. To hide transaction amounts, Anonymous Zether employs homomorphic encryption and commitment schemes. Homomorphic encryption allows operations on encrypted data without decryption, enabling the transaction amount to be verified while remaining encrypted. Commitment schemes are used to encrypt the transaction amount, ensuring that the amount cannot be tampered with or exposed. By combining these technologies, Anonymous Zether effectively conceals transaction amounts, preventing unauthorized third parties from accessing the specific transaction value. An important feature of Anonymous Zether is its no-trusted-setup design. This means the system does not rely on any centralized trusted party for initialization or key generation. All participants can independently generate and verify cryptographic information without needing to trust other parties. This decentralized design enhances the system's security and reduces the risk of potential single points of failure.

Although the protocol effectively hides the sender, receiver, and transaction amount through zero-knowledge proofs and encryption, thereby providing strong privacy protection, the fully anonymous design of Anonymous Zether prevents regulatory authorities from monitoring and auditing transaction activities. This presents legal and compliance challenges in practice, particularly in areas related to preventing money laundering, terrorism financing, and other illicit activities. Therefore, while Anonymous Zether excels in privacy protection, it faces significant shortcomings in meeting regulatory requirements and ensuring the transparency of legitimate transactions in applications such as central bank digital currencies (CBDCs) and stablecoins.

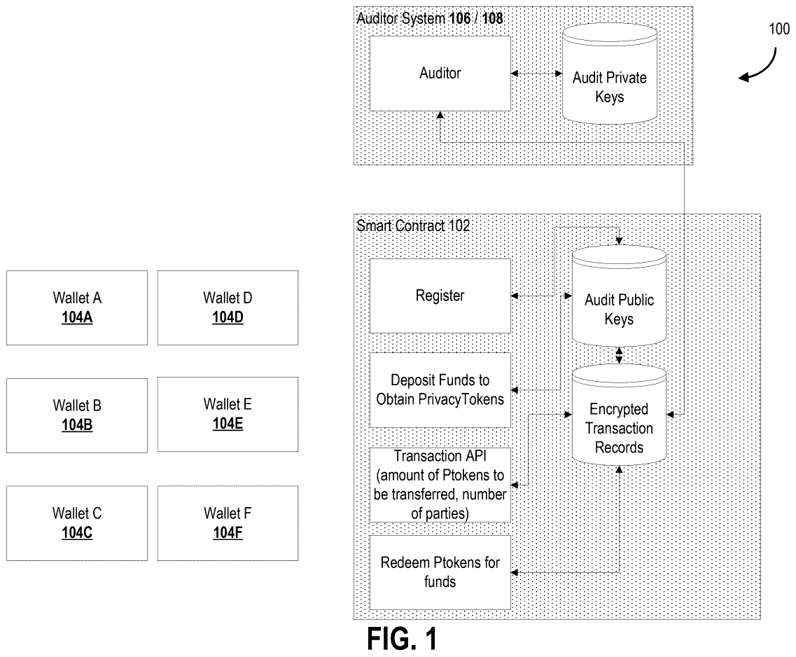

FIG. 1 is a block schematic diagram of an example system for using encryption for selective obfuscation of distributed ledger transactions. In FIG. 1, the example system is a distributed computing system 100 that maintains, updates, and persists a distributed ledger data object across a plurality of computing nodes, each updating the distributed ledger data object in accordance with one or more logical consensus rule mechanisms that are utilized for controlling how updates are broadcast and used to update the distributed ledger data objects so that every copy of the distributed ledger data object on each node is updated with the same records. In some embodiments, the distributed computing system 100 is a decentralized computing system that uses blockchain data objects to represent updates to the distributed computing system using cryptographically hashed data objects that are sequentially coupled together in a series of update blocks, and the distributed computing system 100 is configured for smart contract functionality where the distributed ledger can also be used to provide a runtime environment for transaction execution, operating as a deterministic state machine in accordance with a Turing-complete instruction set.

On the example system is a distributed computing system 100 is a proposed smart contract data object 102 that is specially configured for the improved selective privacy based approach that is adapted for selective obfuscation of distributed ledger transaction records using zero-knowledge proofs and a set of auditor generated public/private key pairs. The purpose of this proposed approach is to improve existing privacy transaction protocols to meet regulatory requirements without compromising the atomic nature of transactions. Specifically, the specialized configuration provides a technical mechanism that allows regulatory authorities to view detailed transaction information, including the sender, receiver, and transaction amount, while ensuring data authenticity, without exposing this information to non-participating parties.

The proposed smart contract data object 102 operates on the distributed computing system 100, and is a smart contract data object 102 that is associated with a plurality of parties to the transaction. The parties are represented through associated public keys relating to specific wallet addresses 104A . . . 104N that can hold digital assets or digital objects on the distributed computing system 100. The number of parties to a transaction, N, can be a controllable factor that is adjustable through the configuration of the underlying execution logic of the proposed smart contract data object 102. The higher the value of N, the more obfuscation is possible (e.g., the two underlying transacting parties are hidden among a larger pool of potential parties), but the corresponding computing expenses (and associated gas execution costs) scale. The smart contract data object 102 is also configured to interact with a reference data object storing auditor public keys that are uniquely associated with each of the specific wallet addresses. The smart contract data object 102 is configured such that digital assets can be stored corresponding to the smart contract data object 102 itself, and transactions can occur as between the parties in the smart contract data object 102, but third parties are not able to decipher the transactions that are occurring because the specific parties and the amounts being transferred are not exposed.

As described herein, the smart contract data object 102 uses the auditor public keys in accordance with a proof/attestation approach so that execution records of the smart contract data object 102 can be generated so that either an auditor node 106 or an auditor computing process 108 are able to interrogate the execution records and decipher, for a particular transaction, who the underlying parties among 104A . . . 104N and the transaction amount. This improvement enhances compliance support while maintaining the core privacy protection functions, enabling the system to effectively meet legal and regulatory requirements in a wide range of applications, including central bank digital currencies (CBDCs) and stablecoins.

The auditor node 106 or an auditor computing process 108 can be coupled to a regulator computing system, for example, which is conducting census level analysis or tracking to support regulatory functions, such as auditing compliance, among others. As a downstream activity, once the receipts are deciphered, either in real time or in a batch process, the smart contract data object 102, while protecting the underlying identities of transfers with respect to other third parties, the auditor node 106 or the auditor computing process 108 is able to observe a non-repudiable proof of the transaction. Accordingly, the proposed approach extends existing privacy transaction protocols by introducing a series of features to support regulatory requirements while maintaining transaction privacy. These features are implemented through modifications and extensions to smart contracts, specifically including the following key functions.

First, a computing process (computer function) has been added to support the upload of multiple cryptographic public keys by regulatory authorities.

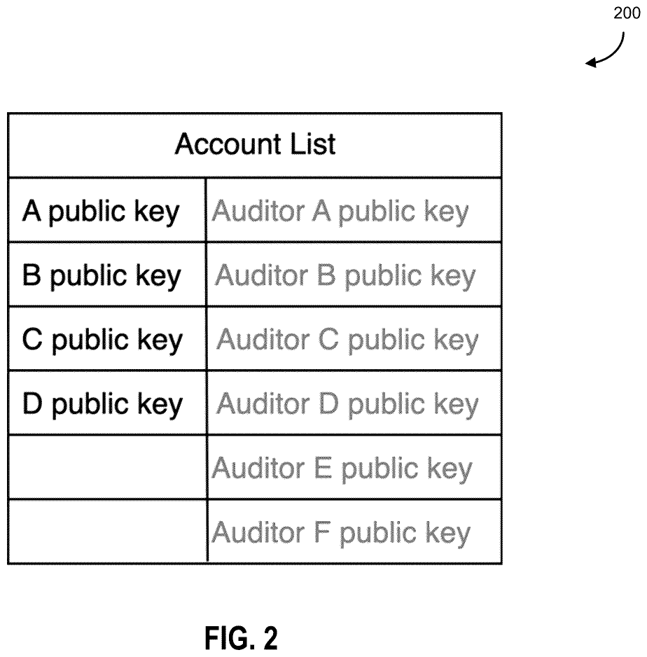

FIG. 2 is an example account list, according to some embodiments. In FIG. 2, the regulatory authorities are able to provide a set of public keys that can, for example, be pre-generated, and then these can each be associated by the smart contract data object 102 to each unique wallet 104A . . . 104N. This first process ensures that only the owner of the smart contract, i.e., the regulatory authority, can invoke it, thereby guaranteeing the security and permission management of public key uploads. These public keys will be used to encrypt future transaction data so that regulatory authorities can decrypt and review it. Second, a computing process has been introduced that allows clients to associate their account public keys 104A . . . 104N with the public keys uploaded by the regulatory authority during privacy account registration. This design ensures that each registered account has a corresponding regulatory public key for data encryption, and it also restricts the number of accounts that can be registered to be less than or equal to the number of public keys uploaded by the regulatory authority. To prevent the exhaustion of public keys, the regulatory authority must set an alert threshold, and public keys need to be replenished in a timely manner when their remaining quantity falls below a certain level.

Finally, an improved computing process for executing privacy transactions using the above public and private keys is conducted through logical instruction sets and instructions on the smart contract data object 102, including the regulatory public and private key. All of the features operate in concert to provide a practical mechanism for enhancing privacy using encryption, while providing a mechanism for an auditor node or auditor process routine (not all variations require a specific auditor node, in some variations, an auditor computer system is configured to access or retrieve records and use the auditor's set of private keys to uncover the anonymous aspects of each transaction).

While retaining the original transaction parameters and functionality, two key data field parameters have been added. The first new data field parameter is an array, with the size matching the number of transaction participants, where each item in the array encrypts the transaction content using the corresponding regulatory authority's public key for each participant. The second new data field parameter is also an array, with the size matching the number of transaction participants, where each item uses zero-knowledge proof technology to prove that the encrypted transaction content in the first parameter matches the actual transaction content in the privacy transaction.

These improvements ensure that regulatory authorities can access the raw transaction data in real-time while maintaining privacy during blockchain transactions, thus meeting legal and compliance requirements, while other unauthorized parties cannot access this sensitive information. Additionally, these additions and modifications strictly preserve the atomic nature of transactions, ensuring the integrity and indivisibility of transactions on the blockchain.

To better illustrate the specific implementation, the following example demonstrates how the core functions of the invention are realized through an extension of Anonymous Zether. In this example, the approach introduces, through the proposed technical features, a representation of a binding relationship between regulatory authorities and users using specific computations and encryption approaches, ensuring regulatory requirements are met while maintaining privacy.

First, a function for registering regulatory accounts has been added. The function takes an array as a parameter, allowing multiple regulatory public keys to be uploaded at once. To ensure security, this function is restricted so that only the owner of the smart contract (i.e., the regulatory authority) can call it, thereby ensuring that only authorized regulatory bodies can upload these public keys.

An example pseudocode snippet describing the computing approach is provided:

```
function registerAuditors(Utils.G1Point[ ] memory _auditors) public onlyOwner {
  uint256 size = _auditors.length;
  for (uint256 i = 0; i < size; i++) {
    auditors.push(_auditors[i]);
  }
}
```

This function allows the smart contract owner to upload multiple regulatory public keys in a single call. These keys will be used to encrypt user transaction data in subsequent transactions, ensuring that only the corresponding regulatory authorities can decrypt and review this data.

Next, the existing user registration function has been modified. While retaining the original registration functionality, additional logic has been added to bind each user to a unique regulatory public key. Specifically, when a user registers, the system checks whether the number of currently registered users is less than the number of uploaded regulatory public keys, ensuring that each user is associated with a distinct regulatory public key. If there are not enough available keys, the system will prevent new user registrations and prompt the need to call the registerAuditors function to upload more public keys. The modified code is as follows:

```
function register(Utils.G1Point memory y, uint256 c, uint256 s) public {
  ... // old register logic remains the same
  require(auditors.length > userCount, “Lack of enough auditors!”);
  userAuditor[yHash] = userCount;
  userCount++;
}
```

With this design, each registered user is automatically bound to a regulatory public key. This binding ensures that transaction privacy is maintained not only from ordinary participants on the blockchain but also that the transaction data is encrypted with the corresponding regulatory public key, allowing regulatory authorities to decrypt and review the transaction content when necessary. This mechanism meets regulatory requirements while protecting user privacy.

To further visualize the implementation of this solution, consider the following scenario: The regulatory authority has previously uploaded six public keys, and four users have successfully registered. Each user's public key is bound to a unique regulatory public key, creating distinct binding relationships. With two public keys still available, the system allows for the registration of two additional users. This design ensures that all users are subject to regulatory review and provides a buffer for handling additional user registrations.

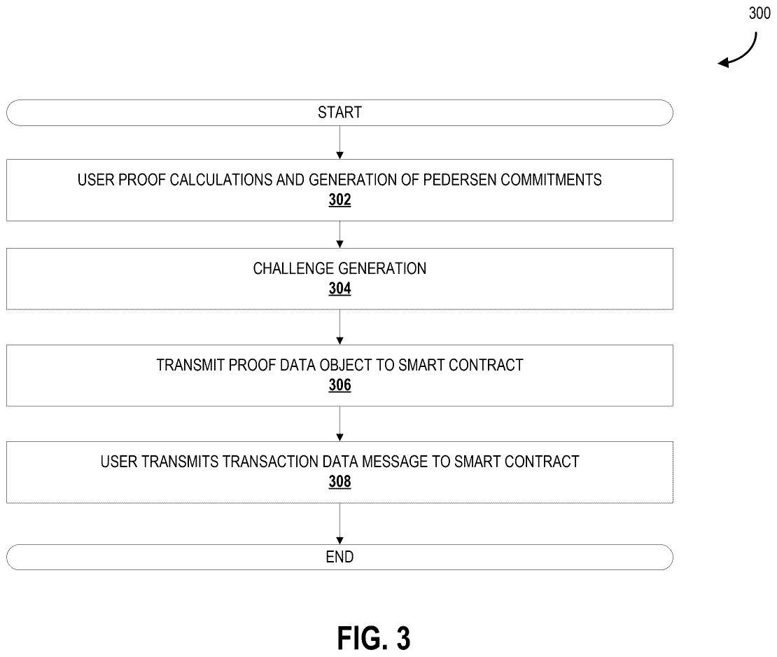

FIG. 3 is a set of method steps showing an approach for executing a transaction, according to some embodiments. The most important modification is to the transfer function of the smart contract data object 102 (used for executing anonymous transactions).

As part of the private transaction, to meet regulatory requirements, the computing approach of method 300 adds two new parameters to the existing transfer function: auditC and auditProof. Both parameters are arrays, with sizes matching the array size of the first parameter C. An example pseudocode is as follows:

```
function transfer(
  Utils.G1Point[ ] memory C,
  Utils.G1Point memory D,
  Utils.G1Point[ ] memory y,
  Utils.G1Point memory u,
  bytes memory proof,
  Utils.G1Point memory beneficiary,
  Utils.G1Point[ ] memory auditC, // new parameter
  bytes[ ] memory auditProof // new parameter
  ) public {
  _transfer(C, D, y, u, proof, beneficiary); // original process
  verifyAudit(C, y, auditC, auditProof); // new process
}
```

In this code, ‘y[i] represents the user's public key, while ‘C[i]’ is the result of encrypting the account balance changes using Pedersen commitment with the user's public key. ‘auditC[i]’ is the result of encrypting the account balance changes using Pedersen commitment with the public key of the regulatory authority bound to the user. This design ensures that the changes in transaction amounts are appropriately encrypted to protect user privacy while allowing regulatory authorities to perform audits.

To prevent users from encrypting forged transaction amounts using the regulatory authority's public keys, it is essential to ensure that the smart contract can verify the authenticity of the transaction amounts. In Anonymous Zether, the validity of transaction amounts has been verified using Bulletproof zero-knowledge proofs. Therefore, in the new ‘auditProof parameter, one only needs to prove that the amounts encrypted in ‘C[i]’ and ‘auditC[i]’ are equal. To achieve this, the proposed method 300 provides a specific practical adaptation using the Sigma Protocol, which is an effective method for proving the relationship between two Pedersen commitment values, to prove that the openings of two Pedersen commitments are equal:

$$C [ i ] = {y [ i ]}^{r} \cdot {g}^{Δ b [ i ]}$$

$$auditC [ i ] = {audity [ i ]}^{r} \cdot {g}^{Δ b [ i ]}$$

The user currently has a wallet and an associated auditor public key. Before officially submitting a transaction to the blockchain, the user must perform a series of random number generation and proof calculations, and then submit the results as one of the parameters at step 302. First at 302, the user generates two random numbers, r1 and r2, and creates two Pedersen commitments respectively:

$${t}_{1} = {g}^{{r}_{1}} \cdot {y [ i ]}^{{r}_{2}}$$

$${t}_{2} = {g}^{{r}_{1}} \cdot {audity [ i ]}^{{r}_{2}}$$

Then at 304, the user creates a challenge. This process can be completely carried out on the user's device, whether it is a computer or a mobile phone.

$$c = Hash ( y [ i ] , g , audity [ i ] , g , C [ i ] , auditC [ i ] , {t}_{1} , {t}_{2} )$$

At 306, the user creates two responses and sends ‘(t1, t2, s1, s2)’ as the proof to the contract, which are sent as one of the parameters sent to the smart contract through a Ethereum node, for example.

$${s}_{1} = {r}_{1} + Δ b [ i ] \cdot c$$

$${s}_{2} = {r}_{2} + Δ b [ i ] \cdot c$$

At 308, if the contract verifies that the following two equations are equal, it proves that the openings of the two Pedersen commitments are the same.

At 308, once the user submits the transaction to the smart contract, the input parameters will include ‘(t1, t2, s1, s2)’.

The contract already stores the user's public key and the associated auditor public key ‘(y[i], audity[i])’, as well as the constant ‘g’ which is set during contract deployment. Additionally, during the execution of the smart contract, the challenge ‘c’ will be recalculated as previously disclosed at 304. Ultimately, the contract will have variables ‘(t1, t2, s1, s2, y[i], audity[i], g)’, which will be used in the following two equations.

If both sides of these two equations are equal, it will prove that the openings of the two Pedersen commitments are the same. It is important to note that the sigma protocol ensures that the user cannot forge the submitted parameters ‘(t1, t2, s1, s2)’ to make the equations hold true within limited computational resources and time.

$${g}^{{s}_{1}} \cdot {y [ i ]}^{{s}_{2}} == {C [ i ]}^{c} \cdot {t}_{1}$$

$${g}^{{s}_{1}} \cdot audit {y [ i ]}^{{s}_{2}} == {auditC [ i ]}^{c} \cdot {t}_{2}$$

Anonymous Zether hides the identities of senders and receivers by involving additional accounts in transactions to achieve privacy protection. The proposed approach extends the auditing functionality on this basis and compares the gas used for general transfers and auditable transfers under different levels of obfuscation.

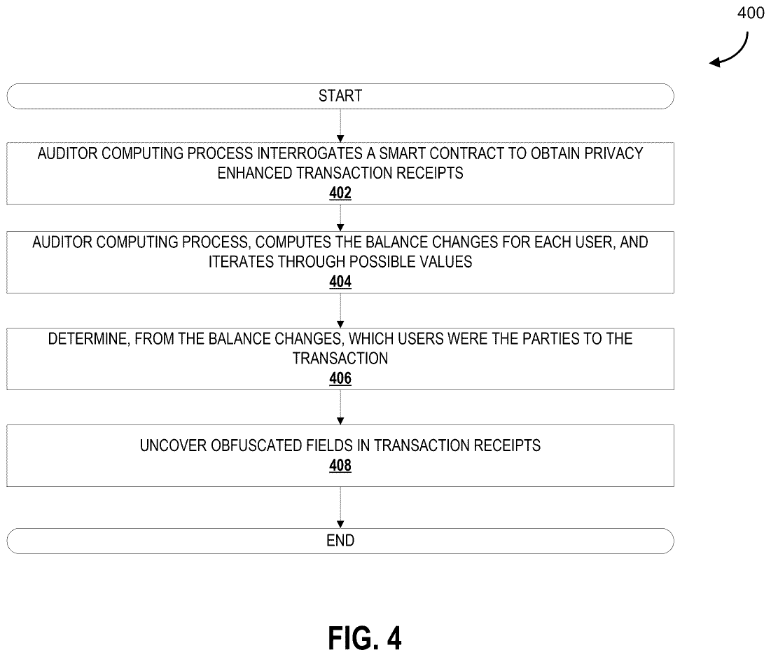

FIG. 4 is a computing method for an audit process that can automatically be conducted by an auditor node or an auditor computing process, according to some embodiments.

In the method 400, the auditor node or the auditor computing process is configured to periodically or in real or near-real time interrogate the smart contract data object 102 to, at 402, obtain one or more transaction receipts corresponding to activities that have occurred on the smart contract data object 102. It is important to note that for any non-auditor observer third party using a tool such as a block explorer, the transaction receipts are accessible, but they are not practically decipherable as it is not made apparent which of the underlying wallets 104A . . . 104N were used in a transaction, or for how much.

Below, a set of example steps explaining for a tool used by a regulatory authority possessing the auditor's private key can extract each user's balance changes from the public events published by the smart contract.

First, the auditor's private key ‘auditx[i]’ corresponds to the public key audity[i]′

$$audity [ i ] = {g}^{auditx [ i ]}$$

Next, when invoking the contract's transfer function at 404, the input parameters include the following two variables:

$$auditC [ i ] = {audity [ i ]}^{r} \cdot {g}^{Δ b [ i ]}$$

$$D = {g}^{r}$$

Then, through a series of mathematical operations, one can compute the formula that includes the balance changes for user ‘i’:

$$\begin{matrix}auditC [ i ] / {D}^{auditx [ i ]} = {audity [ i ]}^{r} \cdot {g}^{Δ b [ i ]} / {( {g}^{r} )}^{auditx [ i ]} \\ = {audity [ i ]}^{r} \cdot {g}^{Δ b [ i ]} / {audity [ i ]}^{r} \\ = {g}^{Δ b [ i ]}\end{matrix}$$

However, since the balance change for user ‘i’ is hidden in the exponent of the formula, we cannot directly obtain it. The approach needs to iterate through all possible values, including zero, positive, and negative numbers. Theoretically, this state space is infinite and cannot be exhausted in a finite amount of time. Fortunately, in real life, the state space for transaction changes is limited, so the possible values that need to be iterated are finite. Often, the answer can be obtained within seconds. After determining the balance changes for each user at 406, the one with negative value are the sender of the transaction, the one with positive value are the receiver, and those with zero values are unrelated users. At 408, the corresponding fields in a transaction log can be updated with the un-obfuscated fields (e.g., to, from, and amount).

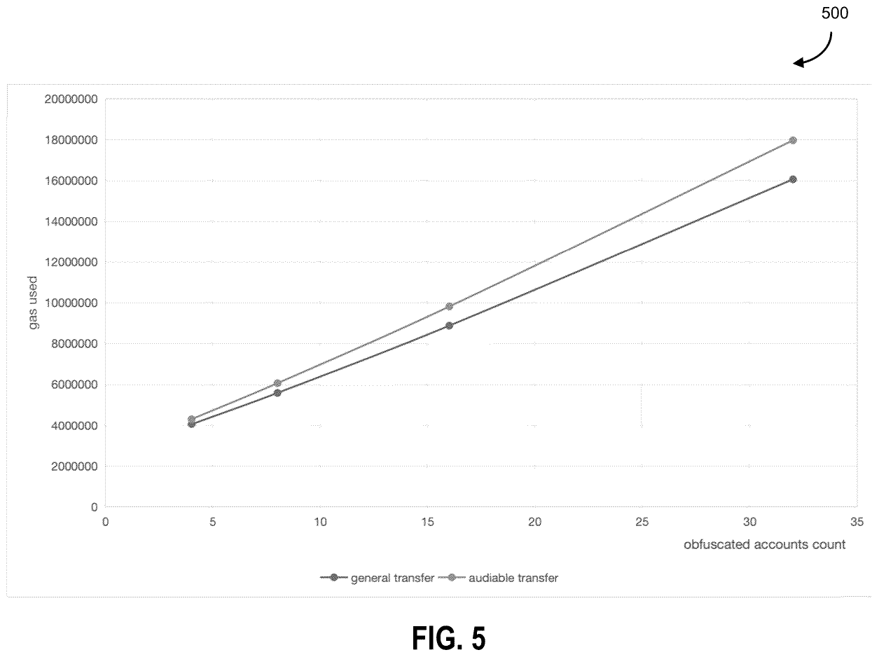

FIG. 5 is a transaction cost graph, according to some embodiments. As shown in FIG. 5, even with the added auditing functionality, the increase in transaction cost is kept within 12%, providing an example experimental validation of the computing efficiency of the system.

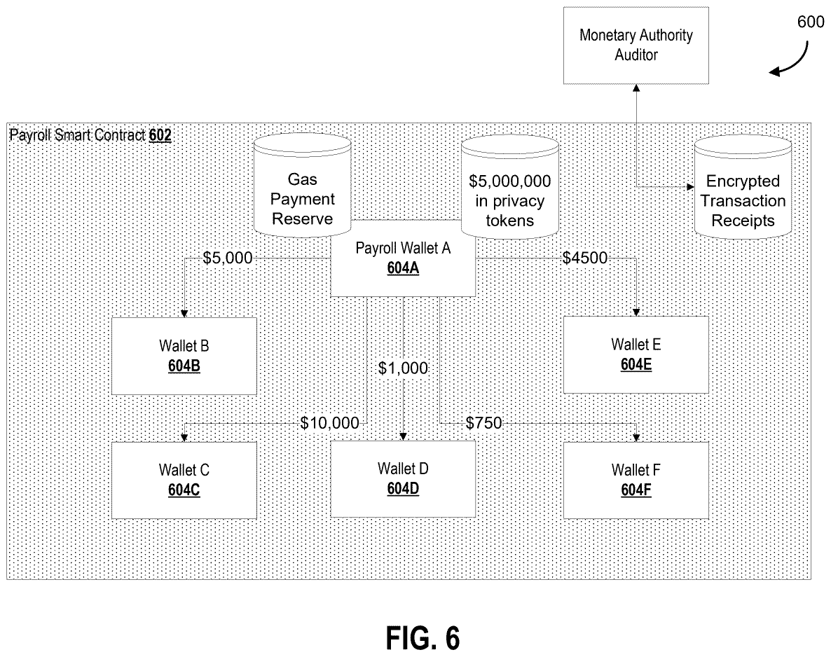

FIG. 6 is an example block schematic of a smart contract data object, according to some embodiments. At FIG. 6, a diagram 600 is provided where an example smart contract data object 602 is deployed in a non-limiting practical applied example, for example, by a financial institution that is providing a payroll function from a payroll wallet A 604A to a number of employees having payroll wallets B . . . F 604B . . . 604F. In this example, there is a high need for privacy as the smart contract is being used to pay various users their pay, which can be different based on individual negotiation and roles and responsibilities.

To encourage a harmonious workplace, the employer may desire to provide each employee to have privacy with respect to other employees. The smart contract data object 602 can be multiple parallel smart contract data objects if there are a high volume of transactions, but in a simplified example, once deployed, the smart contract data object 602 can be used by various individuals wishing to conduct a private transaction, and each smart contract data object 602 can handle multiple transactions that are sequentially executed in the smart contract data object 602. It is estimated that the transactions per second on the smart contract can range from 10-100,000, but ultimately the transaction rate depends on the performance of the blockchain execution infrastructure and network load conditions.

The smart contract data object has a number of exposed functionality: a register function, a get balance function, a transact function, and an extraction function.

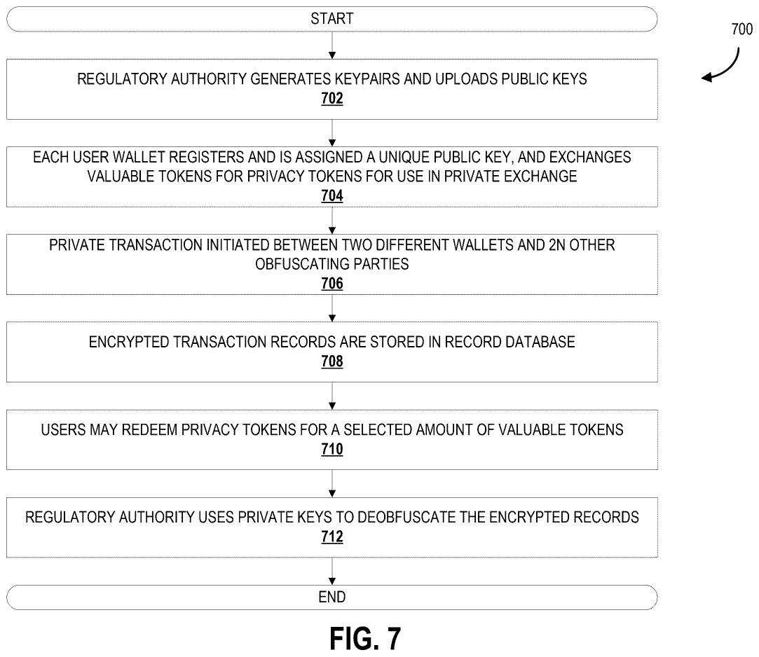

FIG. 7 shows an example set of method steps for performing a private transaction using the proposed smart contract, according to some embodiments. Steps 702, 704, 706, 708, 710, and 712 are example steps for a private transaction between two transacting parties and 2n other obfuscating parties, and each of these steps are implemented by way of API interactions with exposed functions of the smart contract.

In the payroll example, the employer may have the financial institution pay all of the salaries every two weeks, and the private payroll transactions can be executed one by one, in accordance with an execution queue/buffer. The employer, using an employer private payment user interface, may select on the user interface using a toggle bar feature such as a slider that enables a private transaction feature. These payroll payments are then routed through the smart contract 602. It is important to note that the smart contract 602 private transactions will incur computation costs and thus will have increased corresponding gas costs.

In this embodiment, the employer, through the user interface, can also select the total number of parties for the transactions, which allows the employer user to modify the privacy level, at an increasing execution gas cost.

In the example implementation, Applicants used multiples of two, with a minimum of 4 parties, and from a practical perspective, limiting the total number of parties to around 16 to 32. Other example number of parties can include 2, 4, 6, 8, 10. In experimentation, it was found that the gas price for private transactions were only cost effective for larger value transactions, but it is contemplated that for different blockchain infrastructures, different gas costs are possible, so the approach can potentially be used for smaller value transactions and daily transactions. For smaller value transactions or daily transactions, it may also be useful to simply use a smaller number of parties as a balance between cost and privacy.

In this example, at 702, each of the receiver wallets (employees) are interconnected with the smart contract, and have been coupled with a corresponding auditor public key from a set of pre-generated auditor public keys. During the pre-registration process, for example, each of the employees may provide their receiver wallet addresses to the employer, and then couple their personal client mobile applications to the smart contract, and their personal client mobile applications may be configured to interface with the smart contract.

During the registration process, once the recipient (or transferor) has registered their public wallet address, a new private key is generated for usage with the smart contract data object at 704. The new private key is provided back to the user (e.g., the user's mobile application) and can be stored in local data storage. The new private key is not known to any others. In a non-limiting example, each of the personal client mobile applications periodically observes/checks (e.g., polls) the smart contract using the corresponding private key to check if there are digital assets that have been transferred to the receiver wallet. The personal client mobile applications connects directly to the blockchain so no intermediary knows the transaction, even the financial institution. The employer also uses a similar registration function, but the employer also uses a transact function, and an extraction function.

At a point in time after the pre-registration process, in this example, the employer's pay workflow initiates a payroll transaction to the employee. This can be automatically initiated, for example, based on a scheduled pay date. The employer's pay workflow can be an automatic data process which is configured to initiate the transaction in a single function call, where the automatic data process conducts the pre-calculations as described above in the technical description, and submits this to the smart contract data object, along with a number of parties for obfuscation.

The smart contract data object at this stage then selects the other parties for obfuscation, and different approaches can be taken for selection. For example, in a 32 party example, 30 other parties need to be selected. These parties can be other wallets corresponding employees registered to the smart contract data object, other customers, etc., and the smart contract data object can be configured to select these at random, or at the latest active accounts, among others. A benefit of using a set of active accounts is that it makes the obfuscation more effective if a malicious party is seeking to probabilistically uncloak the transaction.

The private transfer function as described in various examples above is utilized at 706 to conduct the private transaction. At this point, only the two transacting parties are able to utilize their private keys to interrogate the smart contract to determine their balances, while to third parties, they are unable to determine the balances of any of the participating wallets. After the transaction is done, Alice's private wallet has increased by her pay, and the payroll private wallet has been decreased, but the obfuscation is conducted with the other parties in the transaction such that third party observers are unable to identify the change in wallet holdings as between the private parties. In this example, in an applied use case, Alice wants to know the updated amount, she can set up a notification or press a button on her mobile application. When she presses the update button in the application, her mobile application will use her private key of his wallet to decrypt and obtain her balance.

Each of the wallets now has a different amount of privacy tokens that were issued as digital funds, and a user may interact with an exposed function on the smart contract to selectively convert the private tokens back to a normal account and redeem public valuable tokens at 710. For example, an employee, Alice has 100 privacy tokens, and she can transfer 20 back to her normal account, and this is publicly available, leaving behind 80 privacy tokens. Accordingly, a third party is not able to fully identify the amount of tokens that Alice has as she did not redeem them all.

In some embodiments, the privacy token generated for usage in the privacy smart contract is a wrapped token of a valuable data object that is assigned to a repository wallet coupled to the smart contract. During redemption at 710, the wrapped tokens are burned and the underlying tokens are released into the redemption wallet address as indicated by Alice.

For the gas costs payments, different approaches can be taken to handle the processing fee costs, and these can include paying privacy tokens to a third party minter service, or in other embodiments, the smart contract may be coupled to a gas repository that the transacting parties have paid into. In the payroll example, the payroll wallet can fund the gas transfer costs for the private transactions.

As described herein, the auditor, such as a monetary authority, may desire to obtain access to the records despite the private transactions, for example, for the purposes of accurately calculating retirement benefits based on salaries. The auditor can run a data process that will check every single transaction in the smart contract, and after the auditor's data process receives an event message that a transaction has taken place, the auditor can decode using their auditor private key to decrypt the message-sender receiver transaction amount—the auditor is recreating the transaction list—every single row is a transaction.

In this example, the auditor can slowly decrypt a huge payroll push as there may be a need to iterate across multiple values. As payroll is not paid frequently, the auditor tool can be configured to periodically operate as a batch process to attain 100% coverage to unlock as required. As the encrypted transaction data sits on the blockchain, the amount cannot be changed or lost, so in some embodiments, even a slow batch process that operates overnight, for example, can be used to attain 100% coverage.

Applied use cases include using the system to check for money laundering, tax non-payment, among others. The auditor, once the records are decrypted, can trace a line of private transactions-from A to B, then to C to D, and can check if intermediary parties in the transaction is problematic, such as a suspected money launderer.

Other use cases for private transactions can include transactions relating to large value objects, such as houses, cars, etc., where the parties are willing to incur the additional gas costs to obfuscate the transaction from third parties but still allow the auditor to retain the capability to decrypt as required.

Further variations can include blockchain or central bank decentralized currency examples where, for example, some transactions can be designated semi-private transactions as between parties. In other variations, it is possible to have a CBDC implementation where every single transaction requires the encryption as described herein.

Another variation can be used for cross-chain implementation, where the smart contract acts as an intermediary as well between different blockchains or different types of objects minted by different institutions that exist on a blockchain.

The proposed approach extends the existing privacy transaction protocols to achieve a balance between privacy protection and regulatory requirements. It allows regulatory authorities to view key transaction information while maintaining transaction privacy, and uses public key encryption and the Sigma Protocol to verify the authenticity and integrity of transaction data, preventing the reception of false data by regulators.

At the same time, the proposed approach preserves the atomic transaction properties and results in only a limited increase in transaction costs. The process includes establishing two new cryptographic parameters for a computational transfer function, C[i], an encrypted account balance change and auditC[i], result of encrypting the account balance changes using Pedersen commitment with the public key of the regulatory authority bound to the user, which are used as part of a Sigma protocol for proving relationship between generated Pedersen commitment values.

The proposed approach involves a selectable number of additional accounts in transactions to obfuscate the identity of the sender and receiver within the additional accounts, and only a computing device with the auditor private key is able to determine the identity of the sender and receiver, as well as the amount being transferred using the approach described herein. While the additional computing process steps necessarily incur additional computational costs (and thus blockchain transaction fees), Applicants conducted testing of the new approach in a practical application integration setting and found that the increase in transaction cost was kept within a practical limit.

In practical application, the approach is an implementation of a multi-chain computing architecture involving the deployment of a main chain and multiple dedicated chains for various activities, as well as dedicated chains for third-party payment channels or platforms, to handle different types of transactions and activities. This architecture not only enhances the system's transaction processing capacity and scalability but also ensures the stability and efficiency of the main chain, effectively supporting large-scale and high-frequency transaction demands. From a practical implementation perspective, especially with a CBDC implementation that uses multiple chains, utilizing cross-chain protocols allows for the transfer of value and data between different chains, which is crucial for achieving flexibility and widespread adoption of CBDCs. Through this method, CBDCs can circulate rapidly between different banks and payment systems, enhancing their liquidity and functionality. From a cybersecurity and privacy perspective, technical mechanisms are proposed herein for data isolation and privacy protection, and the proposed approach emphasizes the protection of user and transaction privacy through physical and data isolation. This design not only meets the privacy protection requirements of modern digital currencies but also satisfies regulatory requirements for preventing money laundering and financial fraud. Finally, the system is configured for additional system security and built-in compliance through its technical configuration. In this solution, the central bank, as the direct manager of the main chain, ensures the security of the digital currency system and financial compliance. Additionally, through the deployment of dedicated chains, the solution can effectively address sudden large-scale transaction demands without impacting the performance of the main chain.

A potential implementation can be done in a transparent, and open-source approach utilizing smart contracts with audited code such that the technical solution allows for the participation of other individuals, enterprises, and financial institutions in blockchain development and maintenance, who would be encouraged by the ability to check the execution code itself. This not only increases the transparency and trustworthiness of the system but also promotes continuous innovation and improvement in technology.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system for selective obfuscation of distributed ledger transaction records within a pre-determined number of a plurality of blockchain wallets persisted on a distributed ledger and each being associated with a corresponding auditor public key, the system comprising:
a computer processor coupled with computer memory and a non-transitory computer readable storage medium, the computer processor configured to:
persist a smart contract data object coupling the plurality of blockchain wallets together with encrypted individual account balances where a sender blockchain wallet and a receiver blockchain wallet confidentially and anonymously conduct a private transaction recorded against the smart contract data object, the private transaction executed using a transfer function, having fields auditC and auditProof, including:
generating two random numbers, r1 and r2, used to generate two Pedersen commitments, t1 and t2;
generating a hash challenge c based at least on a hash transformation of the sender blockchain wallet's public key, the corresponding auditor public key, a result of encrypting account balance changes using t1, wherein t1 is generated using the sender blockchain wallet's public key, and a result of encrypting account balance changes using t2, wherein t2 is generated using the corresponding auditor public key;
generating two responses, s1 and s2, s1 based at least on r1 and the hash challenge c, and s2 based at least on r2 and the hash challenge c; and
recording t1, t2, s1, and s2 as receipt data objects on the smart contract data object as a proof.

2. The system of claim 1, wherein the receipt data objects are stored in a receipt data repository, and an auditor computing process is configured to periodically decipher the receipt data objects to determine, using the auditor private key corresponding to the auditor public key, which of the receipt data objects correspond to which party and a quantity of data objects transferred.

3. The system of claim 2, wherein the auditor computing process uses the deciphered receipt data objects to regenerate a complete transaction log.

4. The system of claim 3, wherein the complete transaction log is periodically processed by the auditor computing process to determine compliance with one or more regulatory reporting requirements.

5. The system of claim 1, wherein the transfer function is utilized to transfer privacy tokens generated for usage with the smart contract data object.

6. The system of claim 5, wherein the privacy tokens are configured for redemption on the smart contract data object to exchange for one or more digital tokens stored in a repository wallet coupled to the smart contract data object.

7. The system of claim 6, wherein the privacy tokens each represent wrapped tokens corresponding to the one or more digital tokens, the wrapped tokens deposited during a registration process of one or more participating digital wallets.

8. The system of claim 7, wherein during the registration process of one or more participating digital wallets, each of the one or more participating digital wallets is assigned a unique auditor public key.

9. The system of claim 8, wherein an auditor computing process is configured to periodically upload a set of auditor public keys for assignment during registration of the one or more participating digital wallets.

10. The system of claim 9, wherein the plurality of blockchain wallets that are coupled together represent different potential payment recipients from a distributing entity, and the distributing entity uses the transfer function to transfer privacy tokens from the distributing entity's private wallet on the smart contract data object to each of the plurality of blockchain wallets, the transfers auditable by the auditor computing process using the corresponding auditor private keys.

11. A method for selective obfuscation of distributed ledger transaction records within a pre-determined number of a plurality of blockchain wallets persisted on a distributed ledger and each being associated with a corresponding auditor public key, the method comprising:
persisting a smart contract data object coupling the plurality of blockchain wallets together with encrypted individual account balances where a sender blockchain wallet and a receiver blockchain wallet confidentially and anonymously conduct a private transaction recorded against the smart contract data object, the private transaction executed using a transfer function, having fields auditC and auditProof, including:
generating two random numbers, r1 and r2, used to generate two Pedersen commitments, t1 and t2;
generating a hash challenge c based at least on a hash transformation of the sender blockchain wallet's public key, the corresponding auditor public key, a result of encrypting account balance changes using t1, wherein t1 is generated using the sender blockchain wallet's public key, and a result of encrypting account balance changes using t2, wherein t2 is generated using the corresponding auditor public key;
generating two responses, s1 and s2, s1 based at least on r1 and the hash challenge c, and s2 based at least on r2 and the hash challenge c; and
recording t1, t2, s1, and s2 as receipt data objects on the smart contract data object as a proof.

12. The method of claim 11, wherein the receipt data objects are stored in a receipt data repository, and an auditor computing process is configured to periodically decipher the receipt data objects to determine, using the auditor private key corresponding to the auditor public key, which of the receipt data objects correspond to which party and a quantity of data objects transferred.

13. The method of claim 12, wherein the auditor computing process uses the deciphered receipt data objects to regenerate a complete transaction log.

14. The method of claim 13, wherein the complete transaction log is periodically processed by the auditor computing process to determine compliance with one or more regulatory reporting requirements.

15. The method of claim 11, wherein the transfer function is utilized to transfer privacy tokens generated for usage with the smart contract data object.

16. The method of claim 15, wherein the privacy tokens are configured for redemption on the smart contract data object to exchange for one or more digital tokens stored in a repository wallet coupled to the smart contract data object.

17. The method of claim 16, wherein the privacy tokens each represent wrapped tokens corresponding to the one or more digital tokens, the wrapped tokens deposited during a registration process of one or more participating digital wallets.

18. The method of claim 17, wherein during the registration process of one or more participating digital wallets, each of the one or more participating digital wallets is assigned a unique auditor public key.

19. The method of claim 18, wherein an auditor computing process is configured to periodically upload a set of auditor public keys for assignment during registration of the one or more participating digital wallets.

20. A non-transitory computer readable medium storing computer interpretable instructions, which when executed by a processor, cause the processor to execute a method for selective obfuscation of distributed ledger transaction records within a pre-determined number of a plurality of blockchain wallets persisted on a distributed ledger and each being associated with a corresponding auditor public key, the method comprising:
persisting a smart contract data object coupling the plurality of blockchain wallets together with encrypted individual account balances where a sender blockchain wallet and a receiver blockchain wallet confidentially and anonymously conduct a private transaction recorded against the smart contract data object, the private transaction executed using a transfer function, having fields auditC and auditProof, including:
generating two random numbers, r1 and r2, used to generate two Pedersen commitments, t1 and t2;
generating a hash challenge c based at least on a hash transformation of the sender blockchain wallet's public key, the corresponding auditor public key, a result of encrypting account balance changes using t1, wherein t1 is generated using the sender blockchain wallet's public key, and a result of encrypting account balance changes using t2, wherein t2 is generated using the corresponding auditor public key;
generating two responses, s1 and s2, s1 based at least on r1 and the hash challenge c, and s2 based at least on r2 and the hash challenge c; and
recording t1, t2, s1, and s2 as receipt data objects on the smart contract data object as a proof.
